(19) United States
(12) Patent Application Publication
(10) Pub. No.: US 2008/0125217 A1
(43) Pub. Date: May 29, 2008

(54) Distribution of verifiable executables

(75) Inventor: Christopher John Pavlovski, Westlake (AU)

Correspondence Address: IBM ENDICOTT (ANTHONY ENGLAND);LAW OFFICE OF ANTHONY ENGLAND, PO Box 5307, AUSTIN, TX, 78763-5307, US

(73) Assignee: International Business Machines Cor

(21) Appl. No.: 11/520,064

(22) Filed: Sep. 13, 2006

(51) Int. Cl. A63F 13/00

(52) U.S. Cl. 463/31

(57) ABSTRACT

Indices and residues for executables are generated. The executables are members of a batch of executables and the generating is responsive to the batch. The index for any particular one of the executables indicates a relationship to the other executables of the batch. A batch signature is generated for the batch of executables, including encrypting a data structure generated responsive to the executables of the batch. The batch signature and respective ones of the executables, indices and residues are sent. The sent executables are not encrypted. One of the users may process a batch signature, residue, index and executable received by the user in order to verify whether the executables received by the user corresponds to one of the sent executables. A definition may also be sent for beginning execution of an executable in a predetermined initial state.

### FIELD OF THE INVENTION

The present invention relates generally to distribution of verifiable executables, and, in particular, to distributing a batch of a plurality of executables over a network wherein verification involves use of a single batch signature for the plurality of executables in the batch.

### BACKGROUND

Mobile phones are increasingly used for entertainment services such as video, messaging, and gaming. In particular, mobile gaming is generating revenue opportunities for mobile phone operators. Presently there exist gaming emulators for personal computers, personal digital assistants, and an elementary emulator has been proposed for mobile phones. There are also gaming scenarios that do not employ an emulator. These include television game shows where mobile users interact via short message service (SMS) using their mobile phone. A drawback of the existing mobile arrangements is that they do not provide adequate security. This diminishes the likelihood of their commercial exploitation. For at least these reasons, a need exists for improved security in mobile devices.

### SUMMARY

The present invention addresses the forgoing need. Disclosed are arrangements, referred to in this description as “verifiable emulator” arrangements, in which gaming images are distributed to mobile phones and verified in both single gaming and multi-player gaming environments. As the term is used herein, a gaming image includes a game executable and may optionally include a game state. The game executable is an executable file that performs a game process when run on a suitable platform. The game state is one or more parameters or files of parameters that establish an initial state of the game process. According to these arrangements, either the same game may be in play by many users, or each user may be playing a different game, together (optionally) with the saved game state.

According to a method form of the present invention, users receive respective executables, wherein the executables are not necessarily themselves encrypted. Nevertheless, a verification process for such a user's device detects whether the user's received executable corresponds exactly to an original executable that a computer system sent to the device.

A first aspect of the verification process includes a user's device processing its received executable together with an index of that executable and a residue of a batch of executables.

As the term is used herein, a “batch” of executables refers to a set of a plurality of executables. A “residue” of a batch of executables, as that term is used herein, includes a data structure formed from a batch of executables. The term “executable” as used herein may refer to a binary executable file or a data structure used in connection with an executable, such as by a process arising from execution of an executable file. For example, a game show server for hosting games may send out questions in the form of data structures for display to users by game processes on mobile devices. The question data structures in this situation may be considered “executables” and may be verified in an application of the present invention.

The received executable is a member of the batch of executables and the index indicates a relationship of the received executable to other executables of the batch.

A second aspect of the verification process includes the user's device decrypting an encrypted batch signature that was also received from the remote computer system.

The “batch signature,” as that term is used herein, is an encrypted data structure that is formed, before the encrypting, from the batch of executables, including the unencrypted executable received by the user's device.

In the first aspect of the verification process, the processing of the executable, index and residue by the user's device includes generating a verification data structure. The verification process may include at least temporarily storing the verification data structure in a tangible, computer-readable medium, which may be in the user's device.

If the executable, index, residue, and batch signature have not been tampered with or otherwise corrupted, the verification data structure matches the decrypted batch signature produced by the decrypting in the second aspect of the verification process. In a checking aspect of the verification process, the user's device checks whether the verification data structure matches the decrypted batch signature.

The executables of the batch have an ordered sequence and the index for the user's executable indicates the order of the user's executable in that sequence. Also, in the forming of the residue for the user's executable, the ones of the hashed executables that are included in the residue are in the ordered sequence. Thus, the index enables the user's device to reconstruct the signature for verification by inserting in the residue a hashed version of the user's received executable into a position as indicted by the user's executable index.

In another aspect of the invention, the residue for the user's executable is formed from hashed executables of the batch, wherein in forming the residue the user's executable is excluded from the executables of the batch.

In another aspect of the invention, the executables may be included in game images and the users may be game players.

In another aspect of the invention, the game images include definitions of respective initial states, so that a game may be initiated from a game image at a predetermined initial state responsive to the definition of initial state included in the game image.

In another aspect of the invention, the users may receive the respective executables, indices, residues and the batch signature from a remote computer system and may store the verification data structure, respective executables, indices, residues and the batch signature in tangible, computer-readable media, which may be in the users' respective devices.

In another aspect of the invention, a user's device may include a mobile phone.

According to another method form of the present invention, a computer system generates respective indices and residues for executables, wherein the executables are members of a batch of executables. The index for any particular one of the executables indicates a relationship of the particular executable to the other executables of the batch. In the generating of the residue for the particular one of the executables, the generating is responsive to the batch of executables. More particularly, the generating of the residue for the particular one of the executables includes generating hashed ones of the executables and combining the hashed ones of the executables, wherein a hash of the particular one of the executables is excluded from the combining.

The computer system also generates a batch signature for the batch of executables. Generating the batch signature includes encrypting a data structure generated responsive to all the executables of the batch of executables.

The method includes sending users respective ones of the executables, wherein the executables are not encrypted, respective ones of the indices, respective ones of the residues and the batch signature.

In another aspect, generating the indices includes ordering the executables of the batch, wherein the index for the particular one of the executables indicates the order of the particular executable. In the generating of the data structure for the residue for the particular one of the executables, the combining of the hashed ones of the executables produces for the residue a combination of the ones of the hashed executables wherein the ones of the hashed executables are included in the residue according to the ordering of the executables.

The method includes generating a verification data structure by generating a hashed executable from the particular executable and inserting the hashed executable into the residue in a position indicted by the particular executable's index. The verification data structure for the particular one of the executables corresponds to the batch signature if the batch signature, the particular executable, and the index and residue for the particular executable have not been altered since being generated by the computer system.

According to another form of the invention, a system includes a processor and a storage device connected to the processor. The storage device is operable for storing a program for controlling the processor. The processor is operative with the program to execute the program for performing steps as described herein above. In a variation, the processor and storage device of the system may be included in a mobile phone. Objects, advantages, additional aspects, variations and other forms of the invention will become apparent upon reading the following detailed description and upon reference to the accompanying drawings.

### BRIEF DESCRIPTION OF THE DRAWINGS

One or more embodiments of the present invention will now be described with reference to the drawings and appendices, in which:

FIG. 1 shows one functional block diagram for a verifiable emulator, according to an embodiment of the present invention.

FIG. 2 is a more detailed functional block diagram of a server and a mobile handset of FIG. 1, according to an embodiment of the present invention.

FIG. 3 is a process flow chart showing how the verifiable emulator of FIG. 1 operates at the server, according to an embodiment of the present invention.

FIG. 4 is a process flow chart showing certain details of a batch signature procedure of FIG. 3, according to an embodiment of the present invention.

FIG. 5 is a process flow chart showing how the verifiable emulator of FIG. 1 operates at the mobile device, according to an embodiment of the present invention.

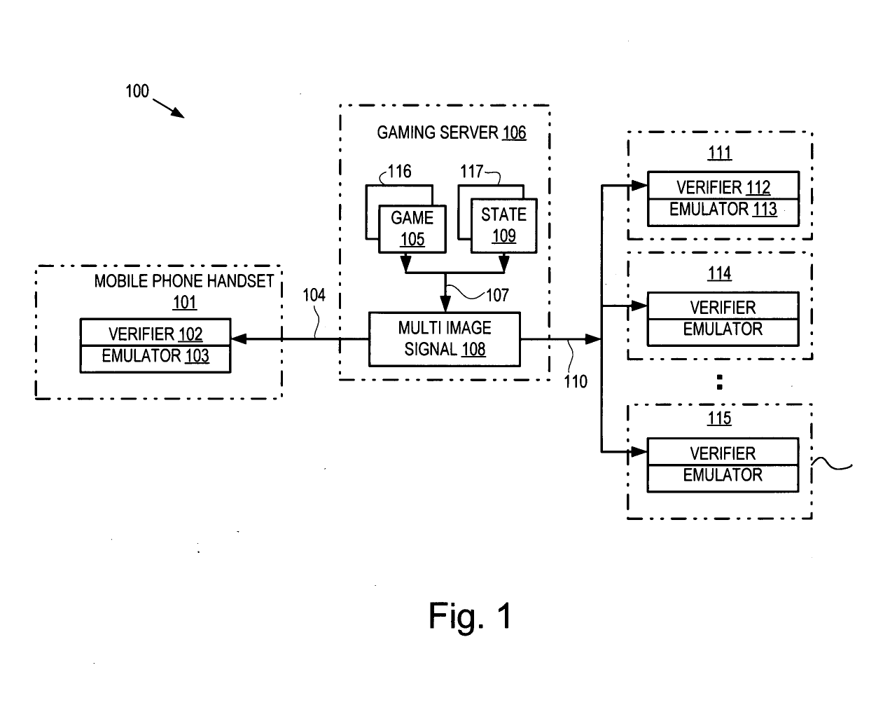

Appendix A contains a code fragment for effecting processes of FIGS. 1-4 in the server, according to an embodiment of the present invention.

Appendix B contains a code fragment for effecting processes of FIGS. 1, 2 and 5 in the mobile device, according to an embodiment of the present invention.

### DETAILED DESCRIPTION OF THE BEST MODE

In the following detailed description of a preferred embodiment, reference is made to the accompanying drawings illustrating embodiments in which the invention may be practiced. It should be understood, however, that the drawings and detailed description are not intended to limit the invention to the particular form disclosed. On the contrary, the intention is to cover all modifications, equivalents and alternatives falling within the spirit and scope of the present invention as defined by the appended claims.

Where reference is made in any one or more of the accompanying drawings to steps and/or features, which have the same reference numerals, those steps and/or features have for the purposes of this description the same function(s) or operation(s), unless the contrary intention appears. Herein the terms “game” and “gaming” are used interchangeably. Likewise, the nouns “step,” “process” and “procedure” and “operation” are used interchangeably, as are the verbs “process” and “operate.” (It should be understood, of course, that a step, for example, may be a process of a larger process, etc.)

FIG. 1 shows one functional block diagram 100 for an embodiment of a verifiable emulator. FIG. 1 shows a gaming server 106, which runs one or more executable software applications for performing games 105. Server 106 communicates, as depicted by an arrow 104, with a mobile handset 101 in the course of conducting a game, which may be a single player game or a multiple player game. For a multiple player game, the gaming server 106 also communicates, as depicted by arrows 11, with additional mobile handsets, such as handsets 111, 114 and 115, as shown in the illustrated embodiment.

Each game such as 105 is associated with one or more game states such as 109, where the game state defines a game image and other parameters necessary to define the state of the game as the time of interest. Gaming server 106 also comprises a multi-image signing module 108 which, together with complimentary functionality (such as a verifier module 102 and an emulator module 103 in handset 101) at one or more of the mobile handsets, performs the verifiable emulator arrangements on the server side. Each mobile handset such as 101 comprises a verifier module 102 and an emulator module 103.

It should be understood from the foregoing that the disclosed verifiable emulator arrangement shown in FIG. 1 includes three components, as follows:

1. Emulator: Gaming emulator that is deployed to the mobile phone;

2. Verifier: Image digital signature verification module on the mobile phone; and

3. Multi-Image Signer: Image digital batch signature signing module on gaming server.

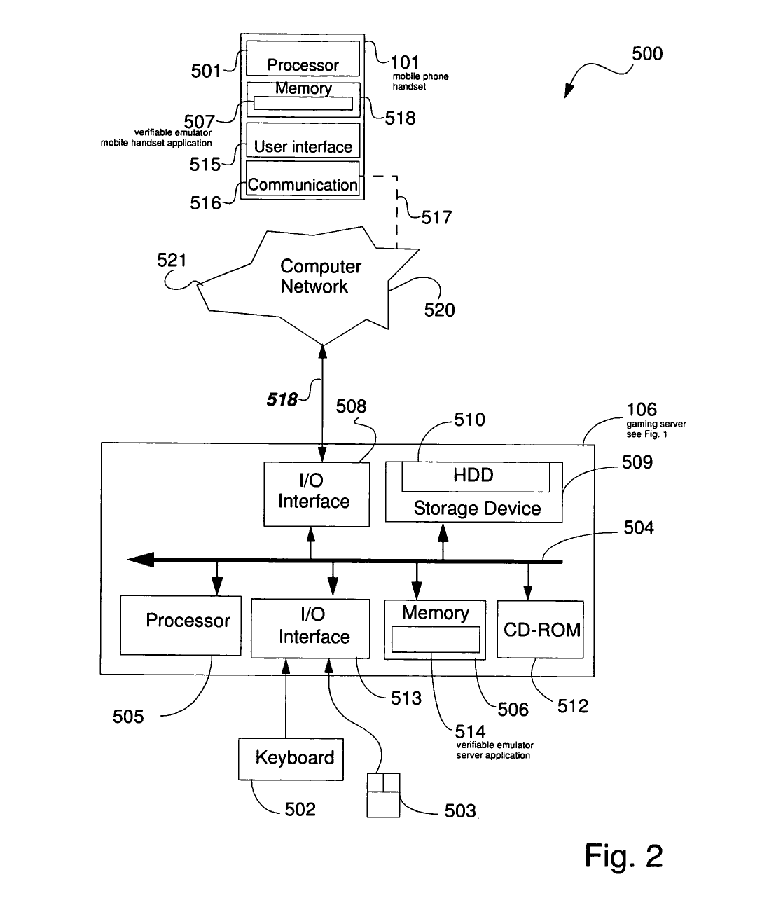

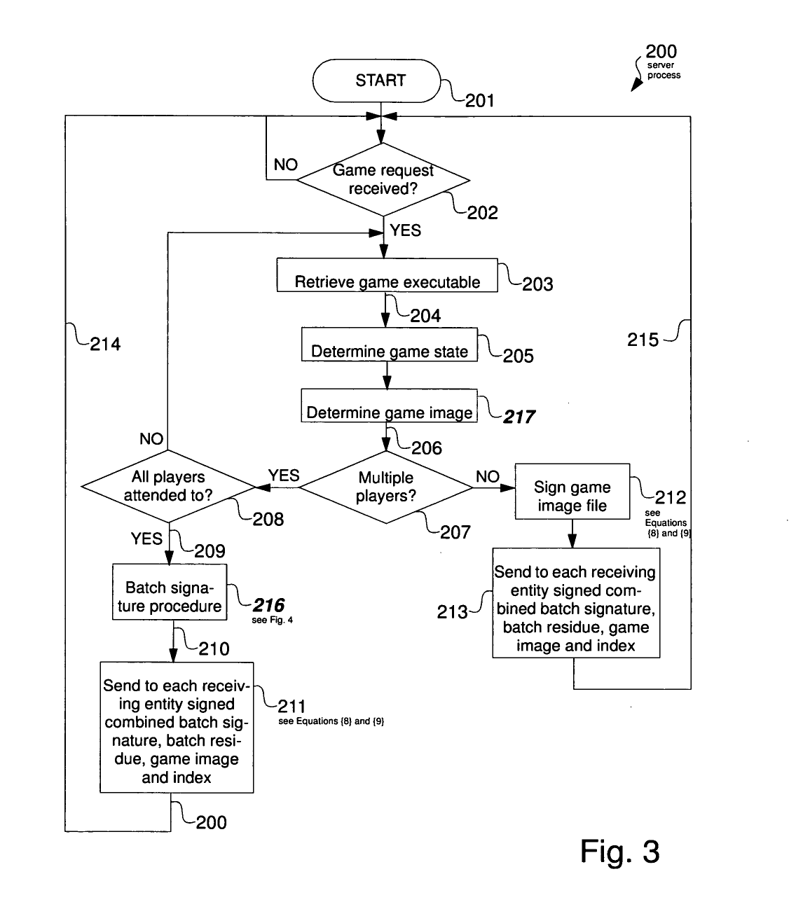

FIG. 2 is a more detailed functional block diagram of server 106 and mobile handset 101 of FIG. 1. The disclosed verifiable emulator arrangements lend themselves to implementation on a system of interconnected computer systems 500, such as that shown in FIG. 2 wherein the processes of FIGS. 3-5 may be implemented as software, such as application programs 514 and 507, executing respectively within the gaming server 106 and the mobile handset 101 and possibly also additional handsets, such as handsets 111, 114 and 115. In particular, the method steps of the verifiable emulator arrangements are effected by instructions in the software modules 514 and 507 that are carried out by the gaming server 106 and the mobile handset 101 (or handset 101 and additional handsets). The instructions may be formed as one or more code modules, each for performing one or more particular tasks. Some or all of the software modules may be divided into two separate parts, in which a first part performs verifiable emulator methods and a second part manages a user interface between the first part and the user. The software modules may be stored in a tangible, computer readable medium, which may include a medium such as a storage device described below, for example. The software modules are loaded into the gaming server 106 and the mobile handset 101 from the computer readable medium, and then executed by the gaming server 106 and the mobile handset 101. A computer readable medium having such software or computer program recorded on it is a computer program product.

Gaming server 106 is a computer system, which in the illustrated embodiment includes input devices such as a keyboard 502 and mouse 503, and output devices including a display device (not shown). An Input/Output interface module 508 included in server 106 is used for communicating to and from a communications network 520.

Gaming server 106, as depicted, includes at least one processor unit 505, and a memory unit 506, for example formed from semiconductor random access memory (RAM) and read only memory (ROM). The illustrated embodiment of gaming server 106 also includes an additional input/output (I/O) interface 513 for keyboard 502 and mouse 503. A storage device 509 is provided and typically includes a hard disk drive 510. A CD-ROM drive 512 is typically provided as a non-volatile source of data storage. In the illustrated embodiment, components 505, 513, 506, 512, 509 and 508 of the gaming server 106 communicate via an interconnected bus 504.

Mobile handset 101 has a processor 501, a memory module 518, which stores the handset-side verifiable emulator software application 507, a user interface 515 comprising a keypad, display and audio device, and a communication module 516 for communicating, as depicted by a dashed line 517, with gaming server 106 over network 520.

Typically, server application program 514 is resident on hard disk drive 510 and read and controlled in its execution by processor 505. Intermediate storage of the program and any data fetched from network 520 may be accomplished using semiconductor memory 506, possibly in concert with hard disk drive 510. In some instances, server application program 514 may be supplied encoded on a CD-ROM (not shown) and read via the corresponding drive 512, or alternatively may be read from network 520 via I/O device 508. Still further, server software 514 can also be loaded into server 106 from other computer readable media. The operation of the handset 101 is similar to that described above for the game server 106.

The term “computer readable medium” as used herein refers to any storage or transmission medium that participates in providing instructions and/or data to either or both game server 106 and/or handset 101 for execution and/or processing. Examples of storage media include CD-ROMs, a hard disk drive, a ROM or integrated circuit, a magneto-optical disk, or a computer readable card such as a PCMCIA card and the like, whether or not such devices are internal or external of server 106 and/or handset 101. Examples of transmission media include radio or infra-red transmission channels as well as a network connection to another computer or networked device, and the Internet or Intranets including e-mail transmissions and information recorded on Websites and the like. According to a disclosed embodiment of the verifiable emulator arrangement, a batch signature algorithm enables one or more games to be signed and distributed to one or more mobile devices for image verification.

FIG. 3 is a flow chart showing a process 200 depicting how the verifiable emulator of FIG. 1 operates in one gaming application at server 106. Process 200, which may be implemented in signing module 108 of FIG. 1, commences with a start step 201 after which in a step 202 server processor 505 determines if a game request has been received from mobile handset 101. A user of handset 101 can initiate a game request by inputting an appropriate command via user interface 515 of handset 101 (see FIG. 2). If this is not the case, then process 200 loops back to step 202 via a NO arrow. If a game request has been received from the communication module 516 of handset 101 via communications network 520, then process 200 follows a YES arrow from step 202 to a step 203. In step 203 server processor 505 retrieves executable file 105 for the game in question from memory 506, and in a following step 205, server processor 505 retrieves game state 109 for the game in question from memory 506. It is noted that executable file 105 for the game in question and game state 109 for the game in question are related to the particular game and the particular state associated with handset 101. In a following step 217, the server processor forms executable file 105 and game state 109 into a gaming image for the game in question. In a following step 207 the server processor determines, from the game request received by step 202, if the game in question is a single or multi-player game.

If step 207 determines that a single player game is being played, then process 200 follows a NO arrow from step 207 to a step 212 in which processor 212 signs the game image file by applying multi-player process 216 to the single game in question. In a following step 213 server processor 505 sends, to the receiving entity in question, a signed combined batch signature, a batch residue, the associated game image and associated game index. (Although there is no need for this in a single game, this permits more general use of the same protocol. It may result in bits of the batch residue and index being set to null, i.e. empy, hence they will not be sent.) Process 200 then follows an arrow 215 back to step 202.

If step 207 determines that a multi-player game is being played, then process 200 follows a YES arrow from step 207 to a step 208 in which server processor 505 if all players have been attended to. If this not the case, then process 200 follows a NO arrow from step 208 back to step 203 in which server processor 505 retrieves the executable file for the game in question from memory 506, and in a following step 205, server processor 505 retrieves the game state for the game in question from memory 506. It is noted that the executable file for the game in question and the game state for the game in question are related to the particular game and the particular state associated with the particular handset being considered in the process loop in question, this loop comprising steps 207, 208, 203 and 205. Thus, for example, the first time the aforementioned loop is executed, handset 101 is the handset in question, and the respective game executable file and game state file are 105 and 109. The second time the loop is executed, handset 111 is the handset in question, and the respective game executable file and game state file are 116 and 117.

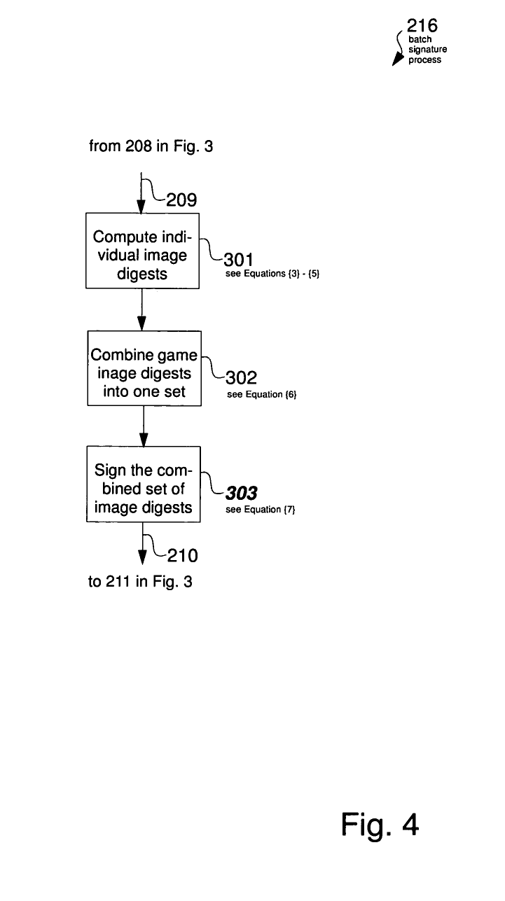

Returning to step 208, if all players have been attended to, then process 200 follows a YES arrow from step 208 to a step 216. In step 216 server processor 505 performs a batch signature process that is described in more detail in regard to FIG. 4. In a following step 211 server processor 505 sends, to each receiving entity, a batch signature, a batch residue, a game image, and a game index, where each receiving entity is sent its own respective batch residue, game image, and game index. Process 200 then follows an arrow 214 back to step 202.

FIG. 4 is a process flow chart showing batch signature procedure 216 of FIG. 3 in more detail. In general terms, procedure 216, which may be implemented in signing module 108 of server 106 in FIG. 1, signs n messages simultaneously, i.e., as a batch, thereby producing a batch signature. Even though the n messages are signed as a batch, procedure 216 may send the n messages independently to n respective recipients for verification. (Although procedure 216 may send all n messages, it is not necessary that all n messages be sent. That is, since messages are independently verified, as described in more detail herein below, it is not necessary for all n messages to be used, even though all n messages are signed in a batch.)

More specifically, according to procedure 216, as shown, one or more game images and saved game states are signed and distributed as follows:

1. Compute individual image digests (301).

2. Combine individual game image digests into one set (302).

3. Sign the combined set of game images using a standard digital signature scheme (303), thereby producing an encrypted file referred to herein as a batch signature.

4. Forward a game image to each player a together with the batch signature (see FIG. 3).

Still more specifically, in the following embodiment of the present invention, the RSA (Rivest, Shamir, and Adleman) signature scheme is used with a modulus n=p.q, (where p and q are large primes) and signature and verification exponents d and e respectively. Use is also made of two collision resistant hash functions denoted H1 and H2, such as Message Digest 5 (MD5). The definition of H incorporates any padding and randomisation such as specified in well known signature preparation algorithms.

In a conventional use of the RSA signature and MD5 hashing function, respective RSA signatures would be calculated for each individual game image as follows:

Signature=H(image)^{d}modn. {1}

These signatures would conventionally be verified for each respective game image by checking that:

Signature^{e}modn=H(image). {2}

In contrast to the above described, conventional use of the RSA signature for individual game images, in the embodiment of the present invention the following steps are used to sign a set of combined images. As depicted in process 216 shown in FIG. 4, step 301 prepares and stores individual digests for game images 1 to N by hashing each game image using a collision resistant hash function H1 to form corresponding game digests, as follows:

Digest_{—}1=H1(image_{—}1) {3}

Digest_{—}2=H1(image_{—}2) {4}

Digest_{—}N=H1(image_{—}N) {5}

A second step 302 computes and stores a combined, hashed set of game digests. That is, in the embodiment of the invention depicted in step 302, procedure 216 computes and stores the hash of the concatenation of the individual digests computed in step 301, including any hash padding and formatting required by the basic RSA signature, as follows:

CombinedDigests=H2(Digest_{—}1∥Digest_{—}2∥ . . . ∥Digest_{—}N). {6}

Herein, the concatenation of the set of game digests is referred to as a “set of concatenated game digests,” and the set of hashed concatenated game digests, i.e., CombinedDigests shown above, is referred to as a “set of hashed concatenated game digests.” Note that the process of step 302 stores the game digests in the resulting set of hashed concatenated game digests CombinedDigests in a predetermined order corresponding to the game indices of the games for the respective game digests, as shown in equation {6} above. That is, the game digest for the game image having game index 1 is the first game digest in CombinedDigests, the game digest for the game image having game index 2 is the second game digest in CombinedDigests, etc.

A third step 303 signs and stores the hashed concatenated game digest set by encrypting CombinedDigests with the application of a private key, creating the following batch signature:

CombinedSignature=(CombinedDigests)^{d}modn. {7}

### It should be appreciated that steps 301-303 advantageously require only one signing operation, even though CombinedDigests may be formed from many games.

After third step 303, process 216 is directed back to FIG. 3, where step process 211 computes and stores a batch residue for each of the n users. Specifically, the batch residue for a user i is the set of all digests, excluding the digest for user i. That is, in equation form:

BatchResidue_{—}i={Digest_{—}j|j=1 to N,j<>i}, {8}

where the symbol <> means not equal to.

### In connection with the above, process 211 associates a game index value i with each game image i and batch residue i and stores the game index values and associations.

Next, process 211 sends to each receiving entity i the combined batched signature, a batch residue i, and a game image i; this being depicted by the following triple:

{CombinedSignature, residue_{—}i, image_{—}i}. {9}

Additionally, since user i needs to know its game index i in order to verify the CombinedSignature, process 211 also sends each user its respective game index i.

According aspects of the embodiment of the invention described above in connection with FIG. 4, a strong one-way hash function is employed to combine a set of messages with computational ease. That is, use is made of a collision resistant hash function together with any digital signature scheme such as RSA. By combining messages into one set, only one digital signature operation is required. That is, a single, batch-wise performance of modular exponentiation, for example, is performed instead of individual performances of modular exponentiation, as would be conventional. Thus, a computational saving arises from using only one signature operation, instead of signing each image individually (i.e. multiple signature operations), as is conventionally done. This provides an improvement in efficiency that increases as the number of game images increase.

Appendix A contains a code fragment effecting, at an overview level, the signing protocol that is performed by signing module 108 of server 106 described herein above, according to an embodiment of the present invention. This may be used for the distribution of signed game images to one or more mobile gamers who have request a particular game image.

The above-noted process is used for both single and multi-player scenarios except that for the multi-player scenario, the process performs a number of loops in order to accommodate the multiple players. That is, the process for generating the batch prior to the signature operation is performed multiple times for multiple players, and only once if there is only a single player. Thus, the process is valid for a single player, and for multiple playing devices; i.e. the process is valid for one or more game players.

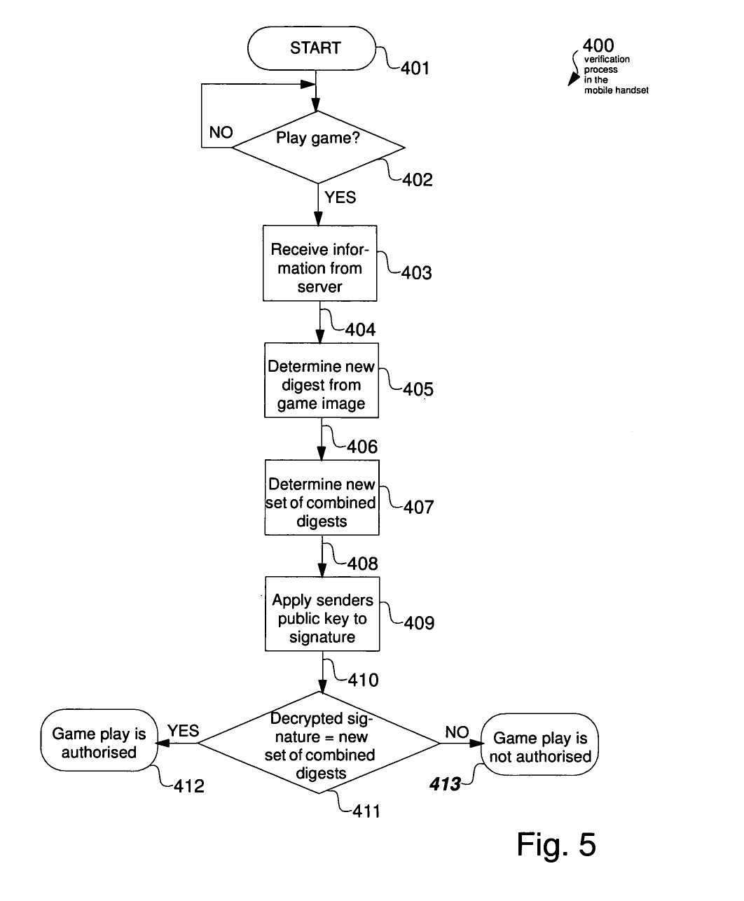

FIG. 5 is a process flow chart showing operation of a process 400 for a verification module, such as a module of verifiable emulator software application 507 as shown in FIG. 1, for a mobile device, such as device 101. Process 400 commences with a start step 401 after which processor 501 in mobile handset 101 determines if a game is to be played. This input can be provided by the user interacting with user interface 515 of mobile handset 101. If a game is not to be played, then process 400 follows a NO arrow and loops back to step 402. If a game is to be played, then process 400 follows a YES arrow from step 402 to a step 403 in which processor 501 in mobile handset 101 receives information via network 520 and connections 518 and 517 from server 106.

Thereafter, in a step 405, processor 501 computes a new digest responsive to the game image received from the server. That is, process 400 of verification module computes a new game digest from the game image. Stated in equation form:

NewDigest_{—}i=H1(image_{—}i) {10}

Then, in a subsequent step 407, processor 501 computes and stores a new set of combined digests. That is, process 400 of the mobile device verification module computes a new set of combined digests in step 407 by inserting the new game digest into a certain position in the supplied batch residue.

Regarding the certain position into which the new game digest is inserted in the supplied batch residue, recall that the game digests in the batch residue are arranged by process 211 in a particular sequence, as described herein above in connection with FIG. 3. In step 407 the new game digest i is inserted in the batch residue i at the location i, at which game i's digest was omitted by process 211 from the sequence of digests 1 through N.

Then step 407 is completed by hashing this new set of concatenated game digests to form a new hashed concatenated game digest NewCombinedDigests. Stated in equation form:

NewCombinedDigests=H2(Digest_{—}1∥ . . . ∥NewDigest_{—}i∥ . . . Digest_{—}N) {11}

Then, in a step 409, processor 501 applies the sender's public key to decrypt the batch signature CombinedSignature that was sent by the server to the mobile handset in step 211 in FIG. 3. In a following step 411, processor 501 compares the decrypted CombinedSignature to the new set of combined digests. Stated in equation form, the comparison determines whether the following statement is true:

NewCombinedDigests=(CombinedSignature)^{e}modn {12}

If the decrypted CombinedSignature is equal to the new set of combined digests, then process 400 follows a YES arrow from step 411 to a step 412 that authorises the game play. If, on the other hand, step 411 determines that the decrypted CombinedSignature is not equal to the new set of combined digests and consequently returns a logical FALSE, then process 400 follows a NO arrow from step 411 to a step 413 that prevents the game play.

During verification, the verification module need only perform one additional hash transformation on message image_i, before inserting this into its correct position. The emulator will only play games that verify correctly. This provides authentication of originator, rights protection, and integrity checking (from rogue applications).

Appendix B contains a code fragment for effecting the verification process of software application 507 in a mobile device, according to an embodiment of the present invention. The disclosed verifiable emulator arrangements can be used, for example, in a number of Gaming Application Scenarios set out below.

Single Player

In this application of the disclosed verifiable emulator arrangement, one game player accesses gaming server, downloads a game, verifies the image and then commences game-play.

Multiple Players (Non-Networked)

In this application of the disclosed verifiable emulator arrangement, multiple game players access the gaming server, requesting the same or different games for download. The sever signs and send of multiple games to mobile devices. The retrieved image is then verified by each gamer individually after which game play commences.

Networked Multi-Player Gaming

In this application of the disclosed verifiable emulator arrangement, multiple game players access the gaming server, requesting the same game for download.

The retrieved image is then verified by each gamer and they then commence multi-player network gaming. In this environment, each player can be confident that no player has cheated by using the correct saved game state. This is conducted by issuing a challenge to another gamer requesting the signature residue and their saved game state, which may then be verified by the challenger.

Heterogeneous Device Support

The verifiable emulator also allows a gamer to save their game and resume from either the same device or an alternate device. This is also the case for single and multiple game player scenarios.

Broadcast Gaming

In this application of the disclosed verifiable emulator arrangement, gamers are required to log into a gaming server to participate in a centralised game that is controlled and executed at the server; for example a TV game show, quiz, or scholastic test. The gaming server may send individual images to a set of registered users. Each user is assured of the authenticity of the individual message sent to them during game-play.

A verifiable mobile gaming emulator has been disclosed that provides a capability to verify gaming images distributed to the mobile phone in both a single gaming and multi-player gaming environment. This includes the download and verification of the same or different game images, together with saved game state. The disclosed signing protocols can sometimes provide significant computational efficiency when distributing gaming images to several gaming players at once, by reducing the computation effort required for signing a set of game images. The disclosed verifiable emulator arrangements can sometimes provide significant advantages over other current approaches, and also provides functions that the OMA digital rights management specification does not address. In addition to the efficient image signing technique, disclosed verifiable emulator arrangements can support copyright protection and integrity checking to ensure that the downloaded image is authentic and not illegally modified.

The Open Mobile Alliance (OMA) specifies a Digital Rights Management (DRM) framework that supports some aspects of rights management and encryption. Three levels of DRM protection are typically supported including:

1. Forward Lock: The DRM message tell the device not to forward the content onto another device (there is no encryption or digital signing).

2. Combined Delivery: In addition to forward lock rights definition are provided in the same message. The rights definition outline how the content may be used on the receiving device; e.g. play only once (there is no encryption or digital signing).

3. Separate Delivery: Content and rights definition are delivered as separate messages to the mobile device. In addition, the content is encrypted (there is no digital signing).

In order for the disclosed verifiable emulator arrangement to be practiced in an OMA environment, DRM must be supported by the mobile device. The OMA DRM specification does not treat the idea of a singing one or multiple different game images, a gaming emulator, and the downloading and verification of game images (and game state) to mobile device. However, as an extension to the invention proposed herein, where encryption is required OMA DRM can be modified to implement this feature.

The disclosed verifiable emulator arrangements have many potential applications that involve both a mobile and fixed device over a single network, these applications including:
Downloading a signed game image to a mobile phone for off-line single gaming;
Downloading a signed game image to a mobile phone and restore a previously saved game state;
Downloading a signed game image to multiple players, each with their own personal (and different) game and game state for play individually; and
Downloading a signed game image to multiple players, each with their own personal (and different) game and game state for play in a multi-player networked environment.

In addition to the potential gaming in mobile phone environments, variations to the above combination include multiple devices:
Downloading a signed game image for a single player to an alternative device (e.g. PDA) and restore a previously saved game state; and
Downloading a signed game image for multiple players to alternative devices (e.g. PDA) and restore a previously saved game state.

Furthermore, in a multiple gaming environment, several game image files require signing by the gaming server. Conventional signing protocols would require execution of the digital signature routine n times for n game images. In the proposed invention, the n images may first combined and then signed in one digital signature routine using a digital signature technique for signing multiple images. Specifically this means that:
The computational efficiency for the gaming server for digital signing of game images remains relatively constant as the number of game images to be signed increases.

### INDUSTRIAL APPLICABILITY

It is apparent from the above that the arrangements described are applicable to the gaming industry.

The foregoing describes only some embodiments of the present invention, and modifications and/or changes can be made thereto without departing from the scope and spirit of the invention, the embodiments being illustrative and not restrictive.

Thus, although the description is directed to distributed gaming applications operating between a gaming server and a mobile handset, the gaming example is only a particular example of a distributed process running between a mobile handset and a server.

Verification may include both copyright protection and integrity checking to ensure that the downloaded image is rights protected and not illegally modified. Furthermore, the verification protocols disclosed herein offer a significant computational efficiency when distributing gaming images in a multi-player gaming scenario. This form of gaming is gaining significant momentum within the mobile gaming industry. The efficiency gain obtained at the server, due to the signature protocol outlined herein, increases in a linear manner as more network gamers join a multi-player game. In particular, the disclosed protocol for combining multiple game images and using a single mathematical exponentiation versus using a separate exponentiation for each game gives the efficiency. An exponentiation is a computationally expensive operation and to do this for each game can take a long time.

In the disclosed verifiable emulator arrangements additional capabilities are provided to sign the image file thereby allowing another party to authenticate the originating entity distributing the game image, this originating entity being the game server in the disclosed examples. The term “sign” means to digitally sign content using a suitable signature key, such as is performed in public key cryptography. In addition, a capability is provided for signing one image or multiple (different) game images using a modified signature technique that provides significant improvement in computational efficiencies over current techniques as the number of game images increases, these being game images which are to be distributed to multiple gamers.

The disclosed verifiable emulator arrangements depict a system for distributing verifiable gaming images (a gaming image comprises the game executable and optionally a game state, the game state including a game image) to either a single player or multiple players simultaneously.

Specifically, the gaming emulator, running on the mobile handset, provides the following capabilities:
ability to receive a game image and execute the game executable without dependency upon the mobile device hardware processor platform. In this regard, the game runs within the emulator, and the emulator is the component which is specifically designed for the mobile device. Any differences between devices is accommodated, and hidden, by the emulator, and hence the game is only designed once. The aforementioned concept is the same as that of a Java® virtual machine.
ability to verify the originator and authenticity of the gaming image.
ability to verify the integrity of the image file and the gaming state.
ability to only unlock and access the game image and game state specifically signed for the user, thereby enabling the game process to proceed.

The disclosed verifiable emulator arrangements also comprise a gaming server that is responsible for signing and distributing the gaming images. The gaming server has the following capabilities:
ability to uniquely sign a game image file so that the emulator on the mobile device is able to confirm authenticity and integrity of image file.
ability to uniquely sign multiple game image files simultaneously for distribution to multiple players at a computational cost that is almost as efficient as the computational cost of signing one image file using the modified signature protocol outlined (see the mathematical description below for more detail).
ability to sign game image files so that only the designated player may unlock the game file and access their personal gaming state.

According to one embodiment of the present invention, a method of enabling commencement of a process between a server and a mobile terminal depends upon the mobile terminal verifying signed information previously passed from the server to the mobile terminal. The signed information can include an executable application for running the process, and a state variable establishing a process state from which commencement of the process is to start.

The mobile terminal may be adapted to verify signed information sent from the server as a pre-condition to enabling commencement of the process between the server and the mobile terminal. Also, the server may be adapted to send signed information to the mobile terminal, where verification of the signed information by the mobile terminal is a pre-condition for enabling commencement of the process between the server and the mobile terminal.

The description of the present embodiment has been presented for purposes of illustration, but is not intended to be exhaustive or to limit the invention to the form disclosed. Many modifications and variations will be apparent to those of ordinary skill in the art and may be suited to a particular use contemplated, but may be within the scope of the present invention.

It should be understood that while the present invention has been described in the context of a cell phone or mobile terminal having a processor, it should be understood that aspects of the cell phone, including the processor, may be implemented as application-specific integrated circuitry. Accordingly, the term “processor” as used herein should be understood to include application-specific integrated circuitry. Moreover, the processes of the present invention are capable of being distributed in the form of a computer readable medium of instructions. Such computer readable medium may have a variety of forms. The present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

Unless clearly and explicitly stated, the claims that follow are not intended to imply any particular sequence of actions. The inclusion of labels, such as a), b), c) etc., for portions of the claims does not, by itself, imply any particular sequence, but rather is merely to facilitate reference to the portions.

### Appendix A

This Appendix contains a code fragment effecting, at an overview level, a signing protocol as performed in a computer system that prepares signed game images for distribution to one or more mobile gamers, according to an embodiment of the present invention. In the code fragment below, the “HASH” operator is a one-way hash function such as MD5, and the “SIGN” operator is a signature algorithm such as given by the RSA signature scheme.

```
FOR each player i waiting in the game lobby DO
  Retrieve game image_i selected by player i
  IF resuming game THEN
    Retrieve saved game state_i for player i
    SET image_i = Concatenation of game image_i with saved
    game state_i
    SET digest_i = HASH( image_i)
  ELSE
    SET digest_i = HASH(image_i)
  END-IF
  SET games = HASH(Concatenation of games with digest_i)
END-FOR
SET CombinedSignature = SIGN(games)
SET residue_i ={digest_j | j = 1 to N, j < > i}
FOR each player i waiting in the lobby server DO
  Forward image_i, state_i, CombinedSignature, residue_i to player i
END-FOR
```

### Appendix B

This Appendix contains a code fragment effecting a verification process as performed in gamers' devices for verifying received games, according to an embodiment of the present invention. In the code fragment below, the “VERIFY” operator is the verification algorithm such as given by the RSA signature scheme.

```
Retrieve image_i, state_i, CombinedSignature, residue_i
SET NewDigest_i = HASH(Concatenation of game image_i
with saved game state_i)
SET NewCombinedDigests = HASH( residue_i, NewDigest_i)
IF NewCombinedDigests =? VERIFY(CombinedSignature) THEN
  LOAD image_i
  LOAD state_i
ELSE
  ERROR
END-IF
```

I claim:

1. A method comprising:
generating respective indices and residues for executables, wherein the executables are members of a batch of executables and the generating of the residues is responsive to the batch of executables, and wherein the index for any particular one of the executables indicates a relationship of the particular executable to the other executables of the batch;
generating a batch signature for the batch of executables; and
sending users the batch signature and respective ones of the executables, indices and residues, wherein the sent executables are not encrypted and the generating of the batch signature for the batch of executables comprises:
encrypting a data structure generated responsive to a collection of all the executables of the batch of executables;
wherein one of the users may process a batch signature, residue, index and executable received by the one of the users in order to verify whether the executables received by the one of the users corresponds to one of the sent executables.

2. The method of claim 1, wherein generating the residue for a particular one of the executables comprises:
generating hashed ones of the executables; and
combining the hashed ones of the executables, wherein a hash of the particular one of the executables is excluded from the combining.

3. The method of claim 2, wherein generating the indices comprises:
ordering the executables of the batch, wherein the index for the particular one of the executables indicates the order of the particular executable among the executables of the batch.

4. The method of claim 3, wherein in the generating of the residue for the particular one of the executables, the combining of the hashed ones of the executables comprises:
generating for the residue a combination of the ones of the hashed executables, wherein the ones of the hashed executables are included in the residue according to the ordering of the executables.

5. The method of claim 2, wherein a particular one of the executables and the index and residue for the particular one of the executables correspond to a particular verification data structure, wherein the verification data structure is generated by generating a hashed executable from the particular executable and inserting the hashed executable into the residue corresponding to the particular one of the executables in a position indicted by the index corresponding to the particular one of the executables, and wherein the verification data structure for the particular one of the executables corresponds to the batch signature if the batch signature, the particular executable, and the index and residue for the particular executable have not been altered since the batch signature, the particular executable, and the index and residue for the particular executable were generated.

6. The method of claim 1, wherein the executables are included in game images and the users are game players.

7. The method of claim 6, wherein the game images include definitions of respective initial states, so that a game may be initiated from a game image at a predetermined initial state responsive to the definition of initial state included in the game image.

8. A method comprising:
receiving an unencrypted executable, an index of the executable, a residue of a batch of executables and a batch signature file by a user device; and
detecting whether the received executable corresponds to a executable sent to the user device, wherein the detecting includes:
decrypting the batch signature, thereby forming a decrypted batch signature;
processing the received executable, index and residue, wherein the processing includes generating a verification data structure; and
comparing the verification data structure and the decrypted batch signature.

9. The method of claim 8, wherein the received executable is a member of the batch of executables and the received index indicates a relationship of the received executable to other executables of the batch, and wherein generating the verification data structure comprises:
generating a hashed executable responsive to the received executable; and
combining the hashed executable with the residue responsive to the received index.

10. The method of claim 9, wherein the executables of the batch have an order, the received residue includes an ordered combination of hashed ones of the executables of the batch and the received index indicates the order of the received executable among the executables of the batch, and wherein combining the hashed, received executable with the residue comprises:
inserting the hashed executable into the received residue in a position of the ordered combination responsive to the ordering indicated by the received index.

11. The method of claim 8, wherein the executables are included in game images and the users are game players.

12. The method of claim 11, wherein the game images include definitions of respective initial states, and the method comprises:
initiating a game from a received game image at a predetermined initial state responsive to the definition of initial state included in the received game image.

13. A computer program product stored in a tangible, computer-readable media, wherein the computer program product has instructions for execution by a computer for causing the computer to perform steps comprising:
generating respective indices and residues for executables, wherein the executables are members of a batch of executables and the generating of the residues is responsive to the batch of executables, and wherein the index for any particular one of the executables indicates a relationship of the particular executable to the other executables of the batch;
generating a batch signature for the batch of executables; and
sending users the batch signature and respective ones of the executables, indices and residues, wherein the sent executables are not encrypted and the generating of the batch signature for the batch of executables comprises:
encrypting a data structure generated responsive to a collection of all the executables of the batch of executables;
wherein one of the users may process a batch signature, residue, index and executable received by the one of the users in order to verify whether the executables received by the one of the users corresponds to one of the sent executables.

14. The computer program product of claim 13, wherein generating the residue for a particular one of the executables comprises:
generating hashed ones of the executables; and
combining the hashed ones of the executables, wherein a hash of the particular one of the executables is excluded from the combining.

15. The computer program product of claim 14, wherein generating the indices comprises:
ordering the executables of the batch, wherein the index for the particular one of the executables indicates the order of the particular executable among the executables of the batch.

16. The computer program product of claim 15, wherein in the generating of the residue for the particular one of the executables, the combining of the hashed ones of the executables comprises:
generating for the residue a combination of the ones of the hashed executables, wherein the ones of the hashed executables are included in the residue according to the ordering of the executables.

17. The computer program product of claim 14, wherein a particular one of the executables and the index and residue for the particular one of the executables correspond to a particular verification data structure, wherein the verification data structure is generated by generating a hashed executable from the particular executable and inserting the hashed executable into the residue corresponding to the particular one of the executables in a position indicted by the index corresponding to the particular one of the executables, and wherein the verification data structure for the particular one of the executables corresponds to the batch signature if the batch signature, the particular executable, and the index and residue for the particular executable have not been altered since the batch signature, the particular executable, and the index and residue for the particular executable were generated.

18. The computer program product of claim 13, wherein the executables are included in game images and the users are game players.

19. The computer program product of claim 13, wherein the game images include definitions of respective initial states, so that a game may be initiated from a game image at a predetermined initial state responsive to the definition of initial state included in the game image.

20. A computer program product stored in a tangible, computer-readable media, wherein the computer program product has instructions for execution by a computer for causing the computer to perform steps comprising:
receiving an unencrypted executable, an index of the executable, a residue of a batch of executables and a batch signature file by a user device; and
detecting whether the received executable corresponds to a executable sent to the user device, wherein the detecting includes:
decrypting the batch signature, thereby forming a decrypted batch signature;
processing the received executable, index and residue, wherein the processing includes generating a verification data structure; and
comparing the verification data structure and the decrypted batch signature.

21. The computer program product of claim 20, wherein the received executable is a member of the batch of executables and the received index indicates a relationship of the received executable to other executables of the batch, and wherein generating the verification data structure comprises:
generating a hashed executable responsive to the received executable; and
combining the hashed executable with the residue responsive to the received index.

22. The computer program product of claim 21, wherein the executables of the batch have an order, the received residue includes an ordered combination of hashed ones of the executables of the batch and the received index indicates the order of the received executable among the executables of the batch, and wherein combining the hashed, received executable with the residue comprises:
inserting the hashed executable into the received residue in a position of the ordered combination responsive to the ordering indicated by the received index.

23. The computer program product of claim 20, wherein the executables are included in game images and the users are game players.

24. The computer program product of claim 23, wherein the game images include definitions of respective initial states, and the steps comprise:
initiating a game from a received game image at a predetermined initial state responsive to the definition of initial state included in the received game image.

25. A system comprising:
a processor; and
a storage device connected to the processor, wherein the storage device is for storing a program for controlling the processor, and wherein the processor is operative with the program to execute the program for performing the steps of:
generating respective indices and residues for executables, wherein the executables are members of a batch of executables and the generating of the residues is responsive to the batch of executables, and wherein the index for any particular one of the executables indicates a relationship of the particular executable to the other executables of the batch;
generating a batch signature for the batch of executables; and
sending users the batch signature and respective ones of the executables, indices and residues, wherein the sent executables are not encrypted and the generating of the batch signature for the batch of executables comprises:
encrypting a data structure generated responsive to a collection of all the executables of the batch of executables;
wherein one of the users may process a batch signature, residue, index and executable received by the one of the users in order to verify whether the executables received by the one of the users corresponds to one of the sent executables.

26. The system of claim 25, wherein generating the residue for a particular one of the executables comprises:
generating hashed ones of the executables; and
combining the hashed ones of the executables, wherein a hash of the particular one of the executables is excluded from the combining.

27. The system of claim 26, wherein generating the indices comprises:
ordering the executables of the batch, wherein the index for the particular one of the executables indicates the order of the particular executable among the executables of the batch.

28. The system of claim 27, wherein in the generating of the residue for the particular one of the executables, the combining of the hashed ones of the executables comprises:
generating for the residue a combination of the ones of the hashed executables, wherein the ones of the hashed executables are included in the residue according to the ordering of the executables.

29. The system of claim 28, wherein a particular one of the executables and the index and residue for the particular one of the executables correspond to a particular verification data structure, wherein the verification data structure is generated by generating a hashed executable from the particular executable and inserting the hashed executable into the residue corresponding to the particular one of the executables in a position indicted by the index corresponding to the particular one of the executables, and wherein the verification data structure for the particular one of the executables corresponds to the batch signature if the batch signature, the particular executable, and the index and residue for the particular executable have not been altered since the batch signature, the particular executable, and the index and residue for the particular executable were generated.

30. The system of claim 29, wherein the executables are included in game images and the users are game players.

31. The system of claim 30, wherein the game images include definitions of respective initial states, so that a game may be initiated from a game image at a predetermined initial state responsive to the definition of initial state included in the game image.

32. A system comprising:
a processor; and
a storage device connected to the processor, wherein the storage device is for storing a program for controlling the processor, and wherein the processor is operative with the program to execute the program for performing the steps of:
receiving an unencrypted executable, an index of the executable, a residue of a batch of executables and a batch signature file by the system; and
detecting whether the received executable corresponds to a executable sent to the system, wherein the detecting includes:
decrypting the batch signature, thereby forming a decrypted batch signature;
processing the received executable, index and residue, wherein the processing includes generating a verification data structure; and
comparing the verification data structure and the decrypted batch signature.

33. The system of claim 32, wherein the received executable is a member of the batch of executables and the received index indicates a relationship of the received executable to other executables of the batch, and wherein generating the verification data structure comprises:
generating a hashed executable responsive to the received executable; and
combining the hashed executable with the residue responsive to the received index.

34. The system of claim 33, wherein the executables of the batch have an order, the received residue includes an ordered combination of hashed ones of the executables of the batch and the received index indicates the order of the received executable among the executables of the batch, and wherein combining the hashed, received executable with the residue comprises:
inserting the hashed executable into the received residue in a position of the ordered combination responsive to the ordering indicated by the received index.

35. The system of claim 32, wherein the executables are included in game images and the users are game players.

36. The system of claim 35, wherein the game images include definitions of respective initial states, and the system comprises:
initiating a game from a received game image at a predetermined initial state responsive to the definition of initial state included in the received game image.

37. The system of claim 32, wherein the processor and storage device of the system may be included in a mobile phone.
